(19) United States
(12) Patent Application Publication
(10) Pub. No.: US 2005/0242522 A1
(43) Pub. Date: Nov. 3, 2005

(54) Seal between the inner and outer casings of a turbojet section

(75) Inventor: Claude Lejars, Draveil (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 11/086,367

(22) Filed: Mar. 23, 2005

(30) Foreign Application Priority Data
Mar. 26, 2004 (FR) 04 03130

(51) Int. Cl. F16J 15/16

(52) U.S. Cl. 277/584

(57) ABSTRACT

The invention relates to a turbojet section comprising an external casing having a surface that extends radially inwards, an internal casing having an essentially axial wall that extends toward said surface, and a seal located between said wall and said surface to prevent communication between the high and low pressure regions situated on either side of said seal, in which said seal is made in the form of an annular sheet-metal ring comprising an essentially cylindrical first part fixed in a leaktight manner to one face of the axial wall and a second part continuing from said first part and situated in the space separating said axial wall from said radial surface, said second part exhibiting, in section on a radial plane containing the axis of the turbojet, a V-shaped profile and having an end portion in leaktight sliding contact with said radial surface.

The invention relates to the seal between two enclosures of a turbojet enclosed by casings and subject to different pressures.

It relates more specifically to a turbojet section comprising an outer casing having a surface that extends radially inwards, an inner casing having an essentially axial wall that extends toward said surface, and a seal located between said wall and said surface to prevent communication between the high and low pressure regions situated on either side of said seal.

A turbojet comprises an annular channel through which a hot working fluid travels, its temperature and pressure varying as a function of the power demanded of the engine. These temperature variations trigger expansions in the casings around the channel, and certain components, particularly in the turbines, which are subjected to the highest temperatures, require cooling with cool air at high pressure. Cooling is done by taking air from a high-pressure compressor stage. This cooling air travels along enclosures provided between an outer casing and an inner casing of the compressor section and turbine section.

Because of load variations, which cause variations in the temperature and expansion of the casings, play is built into those ends of the two casings of each section remote from their other ends which are bolted together. To prevent leaks between the high-pressure enclosure and the lower-pressure enclosure, which would reduce the efficiency of the engine, the play must be closed by expansible seals capable of withstanding the differences of pressure and temperature between the two enclosures.

U.S. Pat. No. 6,431,555 and U.S. Pat. No. 6,464,457 show annular seals made up of a plurality of plate segments retained by pins on the internal casing and maintained in contact with two respective seats of the two casings by springs. These arrangements necessitate much labor during assembly, and leaks can still occur between neighboring plates.

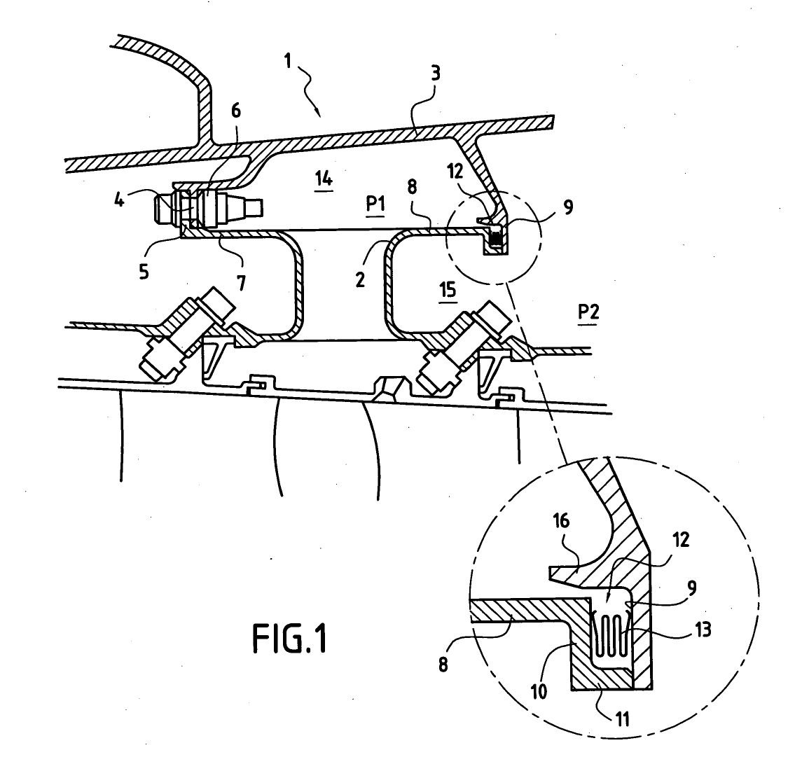

Another technique used in a high-pressure compressor, shown in FIG. 1, involves positioning between two radial surfaces located opposite one another, one on the outer casing and the other on the inner casing, an omega annular seal which takes the form of a bellows held in compression between said two surfaces.

Since in operation there are large relative movements between the two casings forming the cavity of the seal, in both radial and axial directions, this omega seal quickly deteriorates and breaks into several pieces. Sealing is no longer satisfactory, which can result in heating of the turbine cooling air and a modification of the radial play which can degrade the pump margin of the compressor.

Also, the omega seal is held in place radially between two annular complementary axial walls, one formed on the inner casing and the other on the outer casing, at least one of which walls extends toward the radial surface of the other casing and can be subjected to axial stresses under certain operating conditions of the turbojet engine. This requires extra machining to be done to make these complementary axial walls which, under certain conditions, hinder the free expansion of the inner casing relative to the outer casing.

It is a first object of the invention to provide a durable seal between two casings of a turbojet section, by installing a new type of seal better adapted to the operating conditions.

It is another object of the invention to provide a type of seal which will enable a simplification of the structure of the casings at the sealing location.

The invention achieves its object in that the seal is made in the form of an annular sheet-metal ring comprising an essentially cylindrical first part fixed in a leaktight manner to one face of the axial wall and a second part continuing from said first part and situated in the space separating said axial wall from said radial surface, said second part exhibiting, in section on a radial plane containing the axis of the turbojet, a V-shaped profile and having an end portion in leaktight sliding contact with said radial surface.

The proposed seal thus takes the form of a sheet-metal ring having a first cylindrical part which fits onto the cylindrical wall of the inner casing, and a second part consisting of two dished portions that lead into one another, of which the middle portion leads onto the first cylindrical part, the free end of the other dished portion being in sliding contact with the radial surface of the external casing.

The radial wall of the internal casing and the complementary axial walls of the two casings found in the prior art now serve no purpose and can be omitted.

The first part of the seal can be fixed to the axial wall of the internal casing by rivets or bolts.

It may advantageously be fixed to the axial wall of the internal casing by brazing, which improves the sealing in this region. Where this is done, the first part preferably has a constriction sitting in a matching indentation formed on the adjacent face of the axial wall. This prevents axial translational movement of the seal relative to the internal casing.

To ensure sealing under all flight conditions, the second part comes under axial compression when the internal casing is fitted to the external casing.

To improve the radial sliding of the seal over the radial surface of the external casing, the end portion of the second part is bent so that its external axial face is in contact with said radial surface.

The seal according to the invention is so configured that the pressure difference between the high and low pressure regions stresses positively the end portion of the second part toward the radial surface. In other words, if the high pressure region is radially on the outside of the internal casing, the point of the V-shaped section is located radially below the axial wall, and conversely if the low pressure region is radially on the outside of the internal casing the second part is located above the axial wall of the internal casing.

The seal according to the invention is particularly suitable for a high pressure compressor in a turbojet, but it can also be used for other parts of a turbomachinery components, such as the casings of straighteners or the stators of turbines.

Other advantages and features of the invention will be found on reading the following description, which is given by way of example with reference to the appended drawings, in which:

FIG. 1 shows a cross section through a high-pressure compressor of a turbojet comprising a seal in accordance with the prior art, between an internal casing and an external casing;

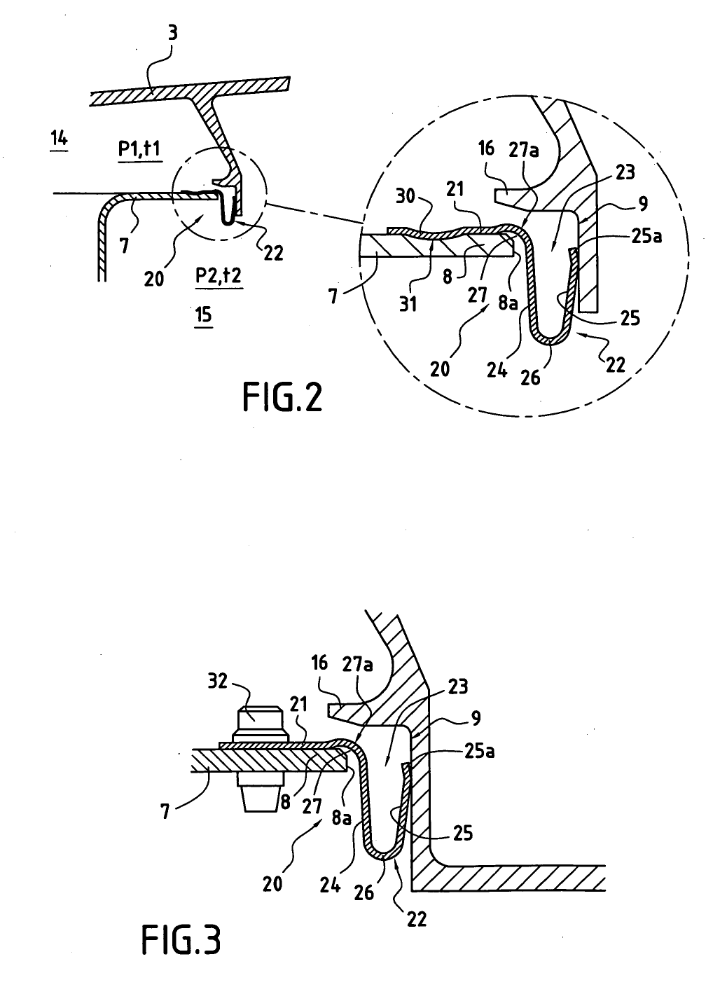

FIG. 2 shows a cross section through the same compressor fitted with a seal in accordance with a first embodiment of the invention; and

FIG. 3 shows a second embodiment of the invention.

FIG. 1 shows a stator 1 of a high-pressure compressor of the prior art, used in a turbojet. This stator 1 comprises an inner casing 2 and an outer casing 3, these being connected upstream by bolts through the flanges 4 and 5 provided on an annular wall 6 of the outer casing 3 and on an essentially axial annular wall 7 of the inner casing 2, respectively. The annular wall 7 continues downstream and its essentially cylindrical end 8 changes direction in front of a radial surface 9 (integral with the outer casing 2) to form a second radial wall 10 which in turn leads into a complementary axial wall 11 which extends as far as the radial surface 9 of the outer casing 2. In the groove 12 bounded by the radial surface 9, the axial wall 11 and the second radial wall 10 is an omega-type seal 13 which is in contact with the -radial surface 9 of the outer casing 3 and with the opposing face of the radial wall 10 of the inner casing 2. A second axial wall 16 is provided on the outer casing 3 above the groove 12.

The omega seal 13 is designed to prevent communication between the enclosure 14 situated beneath the outer casing 3, in which the pressure is P1, and the enclosure 15 situated beneath the end 8 of the axial wall 7, in which the pressure P2 is less than the pressure P1.

FIGS. 2 and 3 show the modifications made to the end 8 of the axial wall 7 and the new seal 20 provided by the invention for preventing communication between the end 8 of the axial wall 7 of the inner casing 2 and the radial surface 9 of the outer casing 3.

According to the invention, the radial wall 10 and the complementary axial wall 11 now serve no purpose and can be completely eliminated, thus facilitating the machining of the downstream end 8 of the annular wall 7. The second axial wall 16 of the external casing 3 can also be omitted.

The seal 20 takes the form of an annular sheet-metal ring comprising two parts 21 and 22 having separate functions. The first part 21 is essentially cylindrical and its diameter is equal to the outside diameter of the end portion 8 of the annular wall 7 of the inner casing 2, so that it can be fitted onto this end portion 8. The second part 22, which forms the seal proper, is placed in the space 23 separating the end face 8a of the axial wall 7 and the radial surface 9, and exhibits, in section on a radial plane containing the axis of the turbojet, a flared V- or U-shaped section.

This second part 22 also comprises two dished portions 24 and 25 which come together in a portion 26 in the form of an annular gutter. The middle dished portion 24 meets the first part 21 via an annular portion 27 whose convex face 27a is on the same side as the enclosure 14 containing a fluid at the pressure P1 and at the temperature t1, the pressure P1 being greater than the pressure P2 in the enclosure 15 situated beneath the axial wall 7 of the inner casing 2.

The other dished portion 25 is slightly bent toward its free end, so that its end portion 25a possesses on its face remote from the first part 21 a convex annular surface in sliding contact with the radial surface 9 of the outer casing 3.

The annular volume lying between the two dished portions 24 and 25 is thus situated inside the high-pressure enclosure 14, and the pressure differences on the two faces of the second part 22 tend to push the dished portion 24 away from the dished portion 25. This prevents communication between the two enclosures 14 and 15 during relative axial or radial movements between the end 8 of the axial wall 7 and the radial surface 9 of the outer enclosure.

In the embodiment shown in FIG. 2, the first part 21 is brazed to the external face of the axial wall 7. The first part 21 advantageously has a constriction 30 which sits in a matching indentation 31 formed on the external face of the axial wall 7 to prevent translational movements of the seal 20.

In the embodiment shown in FIG. 3, the first part 21 of the seal 20 and the end 8 of the axial wall 7 of the inner casing 2 contain holes which are aligned with each other to enable the seal 20 to be bolted or riveted to the end 8 of the axial wall.

Whatever method is selected for mounting the seal 20 on the inner casing 2, the second part 22 is compressed when the inner casing 2 is mounted on the outer casing 3. The geometry of this second part 22 is calculated to offer considerable flexibility. The section of the seal 20 is great enough to enable it to absorb relative movements larger than those permitted by the current omega seal and makes it possible to use a thicker sheet metal, thereby reducing the impact of wear on the contacting faces and makes the seal 20 more vibration-tolerant.

1. A turbojet section comprising an external casing having a surface that extends radially inwards, an internal casing having an essentially axial wall that extends toward said surface, and a seal located between said wall and said surface to prevent communication between the high and low pressure regions situated on either side of said seal,
in which said seal is made in the form of an annular sheet-metal ring comprising an essentially cylindrical first part fixed in a leaktight manner to one face of the axial wall and a second part continuing from said first part and situated in the space separating said axial wall from said radial surface, said second part exhibiting, in section on a radial plane containing the axis of the turbojet, a V-shaped profile and having an end portion in leaktight sliding contact with said radial surface.

2. The turbojet section as claimed in claim 1, in which the first part is fixed to the axial wall by rivets or bolts.

3. The turbojet section as claimed in claim 1, in which the first part is fixed to the axial wall by brazing.

4. The turbojet section as claimed in claim 3, in which the first part has a constriction sitting in a matching indentation formed on the adjacent face of the axial wall.

5. The turbojet section as claimed in claim 1, in which the second part comes under axial compression when the internal casing is fitted to the external casing.

6. The turbojet section as claimed in claim 1, in which the end portion of the second part is bent so that its axially external face is in contact with the radial surface.

7. The turbojet section as claimed in claim 1, in which the seal is so configured that the pressure difference between the high and low pressure regions stresses the end portion of the second part toward the radial surface.

8. The turbojet section as claimed in claim 7, in which the first part is applied to that face of the axial wall which is subject to the high pressure.

9. The turbojet section as claimed in claim 1, in which said section is a high-pressure compressor.
